(19) United States
(12) Patent Application Publication
(10) Pub. No.: US 2005/0115783 A1
(43) Pub. Date: Jun. 2, 2005

(54) Magnetic resistance device

(76) Inventor: Huang-Tung Chang, Chang-Hua (TW)

Correspondence Address: Huang-Tung Chang, P.O. Box 489, Chang-Hua City, 500, TW

(21) Appl. No.: 11/000,971

(22) Filed: Dec. 2, 2004

(30) Foreign Application Priority Data
Dec. 1, 2003 (TW) 092221144

(51) Int. Cl. B62M 1/14

(52) U.S. Cl. 188/267

(57) ABSTRACT

A magnetic resistance device includes a coil member fixed to a shaft and enclosed by a ring member so that the coil member is rotatable relative to the ring member. The ring member is clamped between a fly wheel and a cap. Two bearings are respectively mounted to the shaft and engaged with the fly wheel and the cap. A driving sleeve has a first end inserted in a central hole in the fly wheel and a one-direction bearing is mounted to the first end of the driving sleeve and engaged with the central hole of the fly wheel. A second end of the driving sleeve extends beyond a side of the fly wheel so as to connected to a driving power source via a belt. The coil member is powered by electric power and generates magnetic resistance force when it has relative movement to the ring member.

### FIELD OF THE INVENTION

The present invention relates to a magnetic resistance device which employs relative rotational movement between a coil member and a ring member to control the resistance force.

### BACKGROUND OF THE INVENTION

There are several types of resistance devices used in exercising devices and the resistance force is generated by frictional force, hydraulic force, generator driving force and magnetic force. The frictional force cannot output precise resistance force and the objects that are in contact with each other have to be replaced frequently because of wearing. The hydraulic mechanism for generating the hydraulic force has to worry about leakage and/or noise during operation. The generator is expensive and involves complicated structure which needs to be maintained at high costs. The magnetic force can be obtained by using a permanent magnetic member, nevertheless, the permanent magnetic member cannot be connected to electronic signals so as to precisely control the resistance force.

The present invention intends to provide a magnetic resistance device wherein a relative rotational movement between the coil member and the ring member. The resistance force can be controlled by controlling the current to the coil member.

### SUMMARY OF THE INVENTION

The present invention relates to a magnetic resistance device which comprises a coil member composed of a plurality pairs of coils and a shaft securely extends through a central hole in the coil member. The coil member is enclosed by a ring member so that the coil member is rotatable relative to the ring member. The ring member is clamped between a fly wheel and a cap. Two bearings are respectively mounted to the shaft and engaged with the fly wheel and the cap. A driving sleeve has a first end inserted in a central hole in the fly wheel and a second end of the driving sleeve extends beyond a side of the fly wheel. A one-direction bearing is mounted to the first end of the driving sleeve and engaged with the central hole of the fly wheel. A bearing is mounted to the shaft and engaged with the second end of the driving sleeve.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the magnetic resistance device of the present invention;

FIG. 2 is a perspective view to show the magnetic resistance device of the present invention as shown in FIG. 1;

FIG. 3 is a cross sectional view to show the magnetic resistance device of the present invention as shown in FIG. 1;

FIG. 4 is an exploded view to show a second embodiment of the magnetic resistance device of the present invention;

FIG. 5 is a cross sectional view to show the magnetic resistance device of the present invention as shown in FIG. 4;

FIG. 6 is an exploded view to show a third embodiment of the magnetic resistance device of the present invention, and

FIG. 7 is a cross sectional view to show the magnetic resistance device of the present invention as shown in FIG. 6.

### DETAILED DESCRIPTION OF THE PREFERRED EMBODIMENT

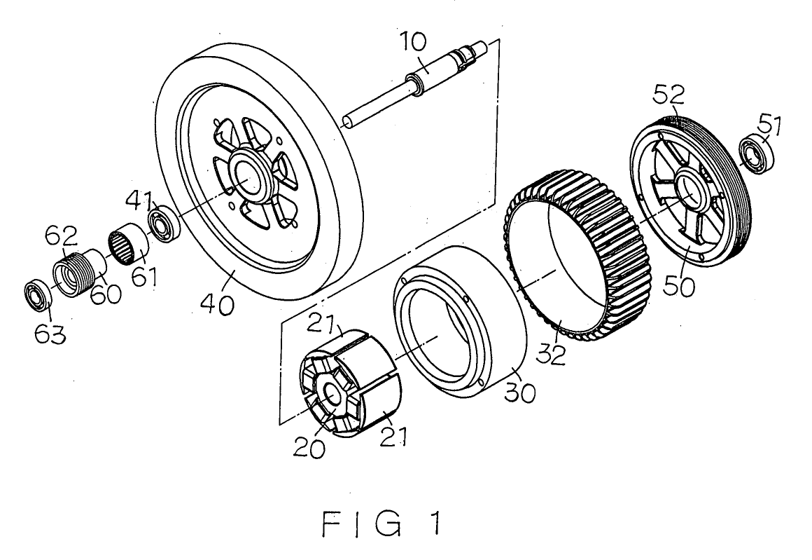

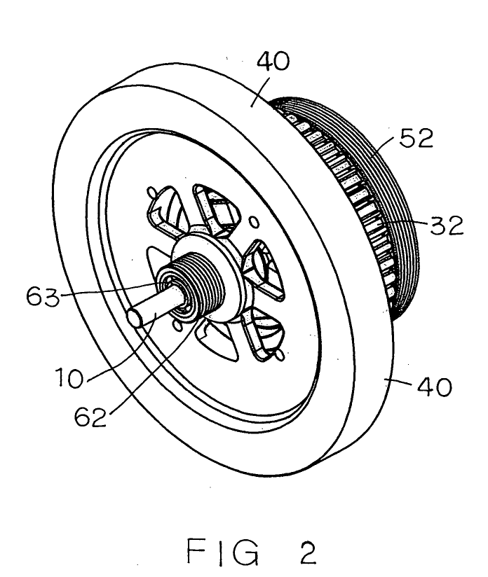

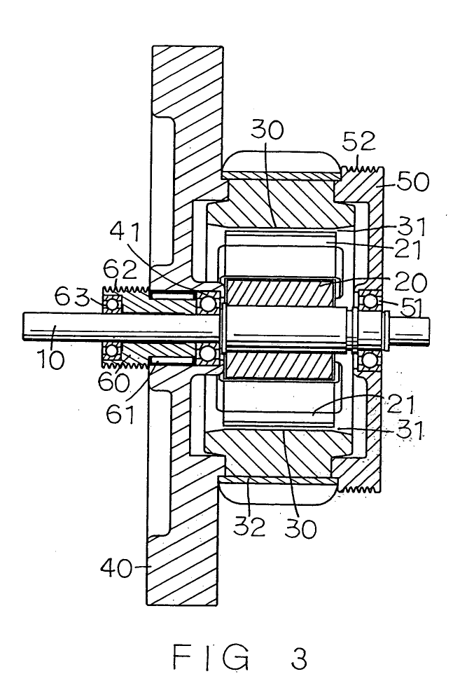

Referring to FIGS. 1 to 3, the first embodiment of the magnetic resistance device of the present invention comprises a coil member 20 which is composed of a plurality pairs of coils 21 and each coil 21 includes an N pole and an S pole. The coils 21 are arranged to form a circle, the N poles and the S poles are arranged in alternative with each other. A shaft 10 securely extends through a central hole in the coil member 20.

The coil member 20 is enclosed by a ring member 30 which is stationary and the coil member 20 is rotatable relative to the ring member 30. A gap is defined between an inner periphery of the ring member 30 and an outer periphery of the coil member 20. The ring member 30 has a heat dispensing ring 32 fixed to an outer periphery of the ring member 30 so as to release the heat generated during the operation of the magnetic resistance device.

The ring member 30 are clamped between a fly wheel 40 and a cap 50. Two bearings 41, 51 are respectively mounted to the shaft 10 and engaged with the fly wheel 40 and the cap 50, such that the ring member 30 is rotated relative to the coil member 20 when the fly wheel 40 is rotated. The cap 50 has a plurality of ridges 52 on an outer periphery thereof so as to drive a belt (not shown) connected to a driving power supply which is not shown.

A driving sleeve 60 has a first end inserted in a central hole in the fly wheel 40 and a second end of the driving sleeve 60 extends beyond a side of the fly wheel 40. A one-direction bearing 61 is mounted to the first end of the driving sleeve 60 and engaged with the central hole of the fly wheel 40. A bearing 63 is mounted to the shaft 10 and engaged with the second end of the driving sleeve 60. The second end of the driving sleeve 60 has a plurality of ridges 62 on an outer periphery thereof so as to drive a belt (not shown) connected to a driving power supply which is not shown.

When the coil member 20 is powered by adequate voltages and the belt drives the fly wheel 40 and the ring member 30 to rotate, the ring member 30 generates a magnetic resistance force due to the magnetic field of the coil member 20. When the belt drives in opposite direction, because of the one-direction bearing 61, the fly wheel 40 and the ring member 30 rotate regardless of the rotation of the driving sleeve 60. Therefore, the magnetic resistance force can be precisely controlled by the input of voltages to the coil member 20.

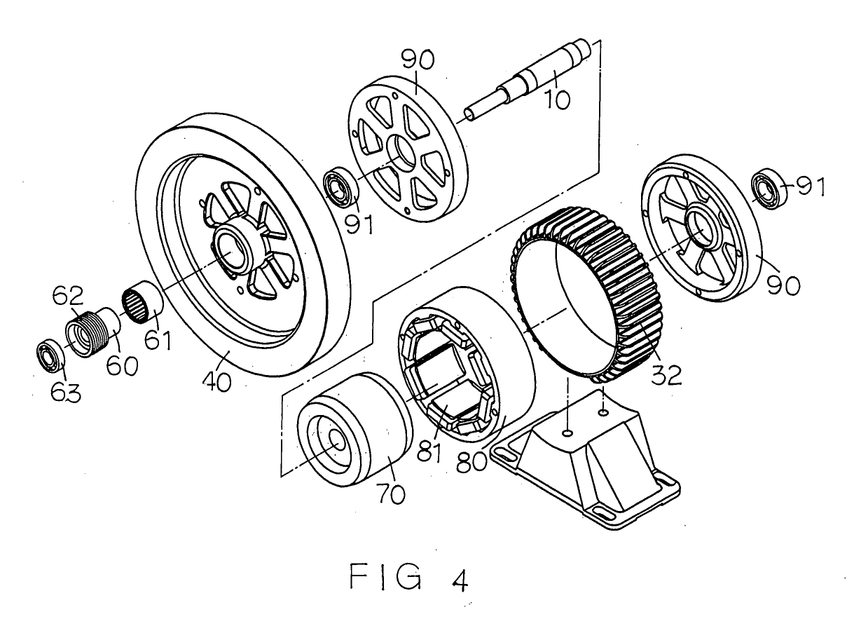

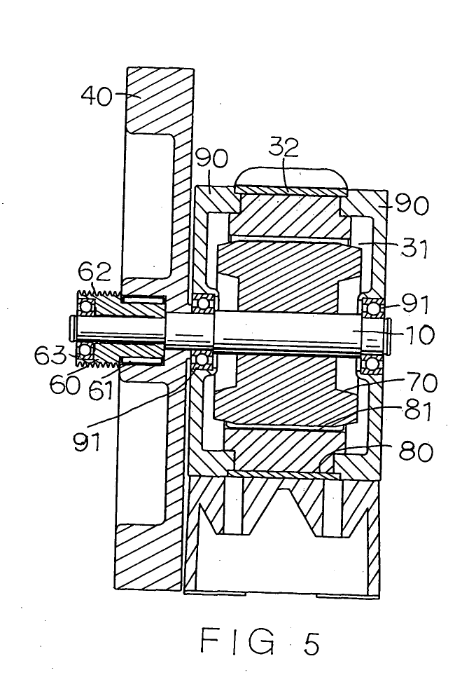

FIGS. 4 and 5 show a second embodiment of the present invention and comprises a coil member 80 composed of a plurality pairs of coils 81 and each coil 81 includes an N pole and an S pole. The coils 81 are arranged to form a circle, and the N poles and the S poles are arranged in alternative with each other. A heat dispensing ring 32 is fixed to an outer periphery of the coil member 80 and connected to a stand.

A ring member 70 is enclosed by the coil member 80 and a shaft 10 securely extends through a central hole in the ring member 70. The ring member 70 is rotatable relative to the coil member 80. A gap is defined between an inner periphery of the coil member 80 and an outer periphery of the ring member 70. The coil member 80 is clamped between two caps 90 and two bearings 91 are mounted to the shaft 10 and engaged with the two caps 90.

A fly wheel 40 is mounted to an end of the shaft 10 and a driving sleeve 60 has a first end inserted in a central hole in the fly wheel 40. A second end of the driving sleeve 60 extends beyond a side of the fly wheel 40. A one-direction bearing 61 is mounted to the first end of the driving sleeve 60 and engaged with the central hole of the fly wheel 40. A bearing 63 is mounted to the shaft 10 and engaged with the second end of the driving sleeve 60. In this embodiment, the ring member 70 rotates and the coil member 80 is stationary.

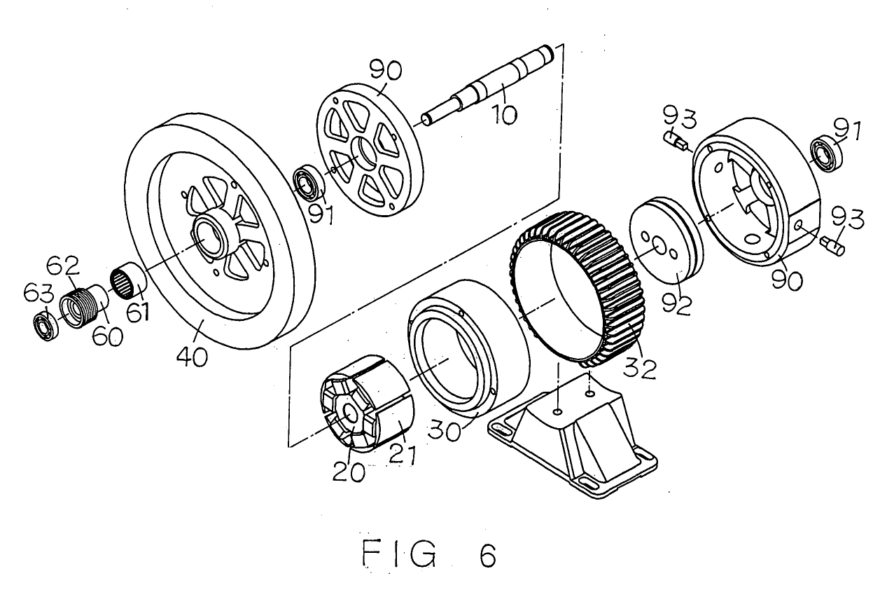

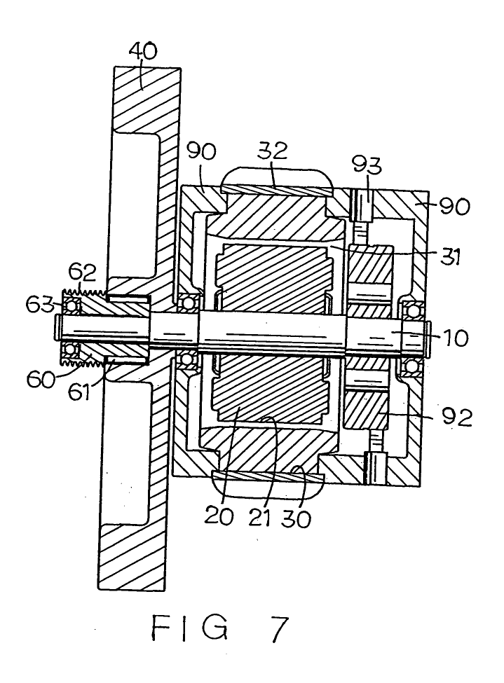

FIGS. 6 and 7 show a third embodiment of the magnetic resistance device which comprises a coil member 20 composed of a plurality pairs of coils 21 and each coil 21 includes an N pole and an S pole. The coils 21 are arranged to form a circle, and the N poles and the S poles are arranged in alternative with each other. A shaft 10 securely extends through a central hole in the coil member 20. The coil member 20 is enclosed by a ring member 30 which is stationary and the coil member 20 is rotatable relative to the ring member 30. A gap is defined between an inner periphery of the ring member 30 and an outer periphery of the coil member 20. The ring member 30 has a heat dispensing ring 32 fixed to an outer periphery of the ring member 30 and is fixed to a stand.

The ring member 30 is clamped between two caps 90. Two bearings 91 are respectively mounted to the shaft 10 and engaged with the two caps 90. Two carbon brushes 93 extend from an inner periphery of one of the two caps 90. A disk 92 is mounted to the shaft 10 and the two carbon brushes 93 are in contact with the disk 92. A fly wheel 40 is mounted to an end of the shaft 10 and a driving sleeve 60 has a first end inserted in a central hole in the fly wheel 40. A second end of the driving sleeve 60 extends beyond a side of the fly wheel 40. A one-direction bearing 61 is mounted to the first end of the driving sleeve 60 and engaged with the central hole of the fly wheel 40. A bearing 63 is mounted to the shaft 10 and engaged with the second end of the driving sleeve 60.

The specific arrangement does not need wires to power the coil member 20 so that the assemblers need not to worry about that wires could be tangled.

While we have shown and described the embodiment in accordance with the present invention, it should be clear to those skilled in the art that further embodiments may be made without departing from the scope of the present invention.

1. A magnetic resistance device comprising:
a coil member composed of a plurality pairs of coils which are arranged to form a circle, a shaft securely extending through a central hole in the coil member;
the coil member being enclosed by a ring member which is stationary and the coil member is rotatable relative to the ring member, a gap defined between an inner periphery of the ring member and an outer periphery of the coil member;
the ring member being clamped between a fly wheel and a cap, two bearings respectively mounted to the shaft and engaged with the fly wheel and the cap, and
a driving sleeve having a first end inserted in a central hole in the fly wheel and a second end of the driving sleeve extending beyond a side of the fly wheel, a one-direction bearing mounted to the first end of the driving sleeve and engaged with the central hole of the fly wheel, a bearing mounted to the shaft and engaged with the second end of the driving sleeve.

2. The device as claimed in claim 1, wherein the ring member has a heat dispensing ring fixed to an outer periphery of the ring member.

3. A magnetic resistance device comprising:
a coil member composed of a plurality pairs of coils which are arranged to form a circle;
a ring member being enclosed by the coil member and a shaft securely extending through a central hole in the ring member, the ring member being rotatable relative to the coil member, a gap defined between an inner periphery of the coil member and an outer periphery of the ring member;
the coil member being clamped between two caps and two bearings mounted to the shaft and engaged with the two caps, and
a fly wheel mounted to an end of the shaft and a driving sleeve having a first end inserted in a central hole in the fly wheel, a second end of the driving sleeve extending beyond a side of the fly wheel, a one-direction bearing mounted to the first end of the driving sleeve and engaged with the central hole of the fly wheel, a bearing mounted to the shaft and engaged with the second end of the driving sleeve.

4. The device as claimed in claim 3, wherein the coil member has a heat dispensing ring fixed to an outer periphery thereof.

5. The device as claimed in claim 4, wherein the heat dispensing ring is fixed to a stand.

6. A magnetic resistance device comprising:
a coil member composed of a plurality pairs of coils which are arranged to form a circle, a shaft securely extending through a central hole in the coil member;
the coil member being enclosed by a ring member which is stationary and the coil member is rotatable relative to the ring member, a gap defined between an inner periphery of the ring member and an outer periphery of the coil member;
the ring member being clamped between two caps, two bearings respectively mounted to the shaft and engaged with the two caps, two carbon brushes extending from an inner periphery of one of the two caps, a disk mounted to the shaft and the two carbon brushes being in contact with the disk, and
a fly wheel mounted to an end of the shaft and a driving sleeve having a first end inserted in a central hole in the fly wheel, a second end of the driving sleeve extending beyond a side of the fly wheel, a one-direction bearing mounted to the first end of the driving sleeve and engaged with the central hole of the fly wheel, a bearing mounted to the shaft and engaged with the second end of the driving sleeve.

7. The device as claimed in claim 6, wherein the ring member has a heat dispensing ring fixed to an outer periphery of the ring member.

8. The device as claimed in claim 7, wherein the heat dispensing ring is fixed to a stand.
